(19) United States
(12) Patent Application Publication
(10) Pub. No.: US 2026/0169896 A1
(43) Pub. Date: Jun. 18, 2026

(54) Data Staging to Overcome External Interface Limits

(71) Applicant: Google LLC, Mountain View, CA (US)

(72) Inventors: Karthikeyan Subramanian, Bengaluru (IN); Kasi Viswanadh Chunduri, Bangalore (IN); Dhivyabharathi Vethanayagam, Bangalore (IN)

(73) Assignee: Google LLC, Mountain View, CA (US)

(21) Appl. No.: 19/532,172

(22) Filed: Feb. 6, 2026

Related U.S. Application Data
(60) Provisional application No. 63/976,781, filed on Feb. 5, 2026.

(51) Int. Cl. G06F 11/3668

(52) U.S. Cl. CPC G06F 11/3672

(57) ABSTRACT

Apparatus and technique(s) are described that configure a computer processor of a device under test to access test workload code over an external interface. The external interface has an address bus width, which limits access to a computer-readable storage media coupled with the processor. The processor may be used to transfer and stage data segment(s) of the test workload code over the external interface. The test workload code is iteratively staged in a target region of the computer-readable storage media, which has a memory address location that the external interface cannot access. Thereafter, a component of the completely transferred and staged test workload code may be accessed by an on-device processor to validate and/or functionally test the device under test.

### CROSS-REFERENCE TO RELATED APPLICATION

This application claims the benefit of U.S. Provisional Patent Application Ser. No. 63/976,781 filed on Feb. 5, 2026, the disclosure of which is incorporated by reference herein in its entirety.

### SUMMARY

This document describes systems and techniques directed at processor-assisted data staging on a device under test (“DUT”) to overcome external interface memory address limitations.

Apparatus and technique(s) are described that configure a computer processor of a device under test to access test workload code over an external interface. The external interface has an address bus width, which limits access to a computer-readable storage media coupled with the processor. The processor may be used to transfer and stage data segment(s) of the test workload code over the external interface. The test workload code is iteratively staged in a target region of the computer-readable storage media, which has a memory address location that the external interface cannot access. Thereafter, a component of the completely transferred and staged test workload code may be accessed by an on-device processor to validate and/or functionally test the device under test.

A computer implemented method may include a processor of a device under test accessing, over an external interface an automatic test equipment test workload code. The method may also include transferring, over the external interface, a data segment of the automatic test equipment test workload code to a temporary buffer region of a computer-readable storage media. The temporary buffer region includes a memory address location of the computer-readable storage media that is accessible by the external interface. The method may further include receiving an instruction to move the data segment. The method may also include executing a copy operation to move the data segment from the temporary buffer region to a target region of the computer-readable storage media. The method may further include operating to determine that the automatic test equipment test workload code has been completely transferred and stored in the target region. The method may also include triggering execution of at least a component of the completely transferred and stored test workload code to perform a functional test of the device under test. This triggering step may further include triggering at least one core of the processor to perform the functional test; and outputting a signal indicative of a result of the functional test. The computer-readable storage media may be a DDR SDRAM. The external interface may have an address bus width of 32 bits. The test workload code may have a size greater than a size of the temporary buffer region.

This document also describes computer-readable media having instructions for performing the above-summarized techniques and other techniques set forth herein, as well as systems and means for performing these techniques.

This Summary is intended to introduce simplified concepts of systems and techniques directed at processor-assisted data staging on a device under test (“DUT”) to overcome external interface memory address limitations, concepts of which are further described below in the Detailed Description and Drawings. This Summary is not intended to identify essential features of the claimed subject matter, nor is it intended for use in determining the scope of the claimed subject matter.

### BRIEF DESCRIPTION OF DRAWINGS

Details of one or more aspects of systems and techniques directed at processor-assisted data transfer over an external interface and staging in a computer-readable storage media of a device under test (“DUT”) to overcome memory address limitations of the external interface, are described herein with reference to the following Drawings:

FIG. 1 illustrates example details of a testing environment in which systems and techniques directed at processor-assisted data transfer over an external interface to overcome memory address limitations of the external interface may be implemented;

FIG. 2 illustrates an example method to overcome memory address limitations of an external interface using processor-assisted data transfer and staging over the external interface;

FIG. 3 illustrates examples of correlative workflows that may be implemented for an internal memory and for a double data rate (“DDR”) dynamic random access memory (“DRAM”) or synchronous dynamic random access memory (“SDRAM”) of a device under test; and

FIG. 4 illustrates a block diagram of an example software architecture that may be used to configure a processing circuit of a device under test.

The same numbers may be used throughout the Drawings to reference like features and components.

### DETAILED DESCRIPTION

### Overview

This document describes techniques and apparatuses directed at processor-assisted data staging on the device under test (“DUT”) to overcome external interface memory address limitations.

Apparatus and techniques disclosed in this document may configure and use a processor of a device under test to overcome a constraint caused when an external interface of the device under test has an address bus width that is smaller than an available memory region (e.g., having a size in gigabytes +) of a dynamic random access memory (“DRAM”) computer-readable storage media (“CRM”) that is coupled with the device under test. Initially, a data segment of an automatic test equipment (“ATE”) test workload code is loaded over the external interface into a temporary buffer region of the CRM that the external interface can access given an address bus width of the external interface. Subsequently, an on-device processor then transfers this data segment from the accessible temporary buffer region to other target regions of the CRM that are beyond an accessible address range of the external interface. This load-and-transfer cycle is repeated until the automatic test equipment (“ATE”) test workload code is completely transferred over the external interface and is staged in the other target location(s) of the CRM.

This approach affords one or more technical advantages. As one example, this approach facilitates loading larger, multi-gigabyte (for example, 10 GB+), complex ATE test workload code into a random access memory (“RAM”), dynamic random access memory (“DRAM”), or synchronous dynamic random access memory (“SDRAM”) of a device under test over an external bus having an address bus width (e.g., 32 bit) that is limited to accessing only a portion of memory address location(s) that are available in the CRM. Advantageously, an external interface having a 32 bit address width, which enables accessing only about 1.5 GB or less of a CRM of a device under test, can now be used by the apparatus and technique(s) of this document to transfer a larger ATE test workload code over the external interface and to stage the complete code in the CRM of the device under test. A technical advantage of this technique is that the transfer of the complete ATE test workload code (or of a complete component thereof) can occur even though the entire test workload code has a size (in megabytes or in gigabytes) greater than a size of a memory address location (about 1.5 GB in this example) of a temporary buffer region of the CRM that the 32 bit external interface can directly access. Another technical advantage of this approach is that it enables use of other target memory storage region(s) of the CRM without requiring additional, dedicated hardware re-mapper logic or complex interface modifications. Because aspects of the apparatus and techniques disclosed in this document do not require specialized memory address re-mapper circuits to extend the memory addressing capabilities of the external interface, overall complexity of hardware designs may be simplified.

Yet another technical advantage is that a size of an ATE test workload code that can be loaded into the DRAM of the device under test is no longer limited to: a memory capacity that correlates to a bit size of the external interface; and/or to a memory capacity of an internal CRM of the device under test (such as a read-only memory “ROM”). Instead, aspects of the apparatus and techniques described in this document eliminate these memory storage limits and bottlenecks. Thus, the address bus width (in bits) of an external interface no longer constrains or limits a size of an ATE test workload that can be completely loaded in a device under test. Consequently, aspects of this approach may yield cost and/or time savings during hardware design workflows. By enabling use of multiple target locations of the CRM for storing, and later reading and executing, one or more components of the completely transferred and staged ATE test workload code, aspects of the apparatus and techniques disclosed in this document may facilitate executing significantly enhanced ATE functional test coverage of a device under test. This approach thus overcomes limitations imposed by smaller on-chip memories or restricted external memory access. This is achieved using existing on-device processor resources, which provides a flexible solution that leverages established hardware architecture.

The techniques and apparatuses described herein may have utility across a variety of field use environments in which it is necessary to validate and test that a design of a device under test meets applicable standards for functionality, reliability, performance, or quality. The device under test may be a computing device or a component of a computing device.

### Testing Environment Overview

Examples of apparatus and techniques are now described that enable moving automatic test equipment (“ATE”) test workload code from a temporary buffer region of a random access memory (“RAM”), dynamic access memory (“DRAM”), or synchronous random access memory (“SDRAM”) computer-readable storage media (“CRM”) of a device under test to a target region. The description first provides a general overview of the ATE apparatus and environment, followed by a detailed breakdown of constituent components and their functional interactions. Finally, example methods of operation are detailed, including one or more software (and/or firmware) based workflows.

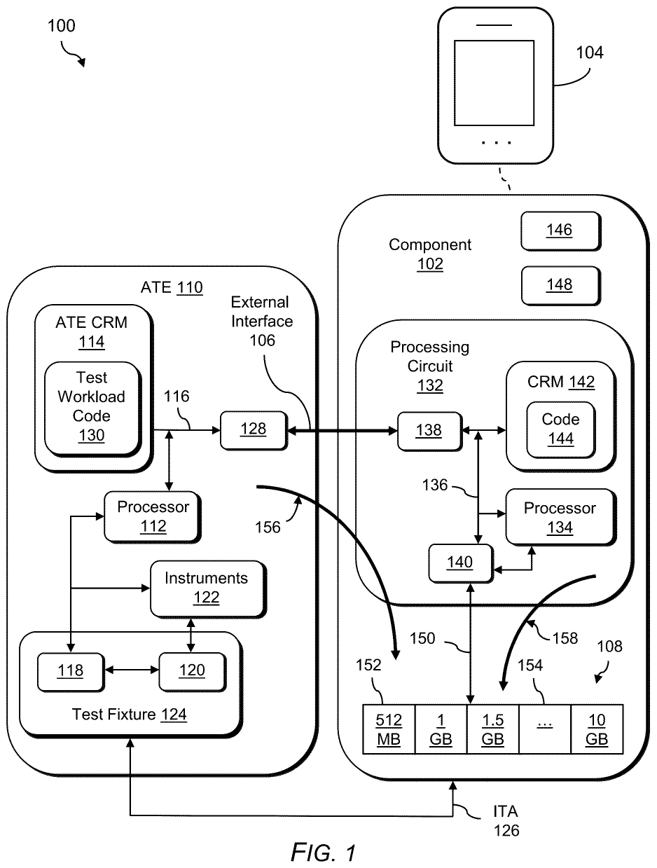

FIG. 1 illustrates example details of a testing environment 100 in which systems and techniques described herein may be implemented. In the testing environment 100, a device under test 102, 104 (e.g., component 102 of a computing device 104 and/or the computing device 104) may be coupled with an ATE machine 110. An external interface 106 enables connecting the device under test 102, 104 with the automatic test equipment (“ATE”) machine 110. The external interface 106 may have an address bus width that limits it to accessing a memory address location that has a memory size that is less than a total available memory size of a dynamic random access memory (“DRAM”) computer-readable storage media (“CRM”) 108. As an example, a 32 bit address bus width of the external interface 106 may limit it to accessing about 1.5 GB or less of memory in the CRM 108, whereas the CRM 108 may have 10 GB+of memory space available.

The ATE machine 110 includes one or more ATE computer processor(s) 112 coupled with an ATE computer-readable storage media (“CRM”) 114 over a data bus 116. The processor(s) 112 of ATE machine 110 may also be coupled with a switching controller 118, which is coupled with switching circuit(s) 120. ATE test equipment and instruments 122 may be coupled with both the switching circuit(s) 120 and the processor(s) 112 of ATE machine 110. The switching controller 118 and the switching circuit(s) 120 may be parts of an ATE test fixture 124. An interface test adapter (“ITA”) 126 may couple one or more devices under test 102, 104 with the ATE test fixture 124. The external interface 106 is depicted, illustratively, as separate from the ITA 126; but in another example, the external interface 106 may be the ITA 126. Additionally, ATE machine 110 may include an ATE external interface controller 128 coupled with the external interface 106, with the processor(s) 112 of ATE machine 110, and/or with ATE CRM 114. The ATE external interface controller 128 may be configured with circuitry and/or software to enable managing one or more data transfer protocol(s) to transfer a complete ATE test workload code 130 from the ATE CRM 114 over the external interface 106 to the CRM 108 of component 102 and/or of computing device 104.

Non-limiting examples of computing device 104 may include: a general purpose computer, a computer server, a mobile device, a display device, and so on. Computing device 104 may be configured for use in various sectors, including without limitation: automotive, robotics, artificial intelligence, and so on.

Component 102 of the computing device 104 may include a processing circuit 132. This processing circuit 132 can be a general-purpose CPU, a core within a system-on-a-chip (SoC), or a specialized co-processor. It may be configured with a memory controller (not shown) that provides access to the full address range of the CRM 108. The processing circuit 132 may include processor(s) 134. Processor(s) 134 may be coupled by an address bus 136 with a component external interface controller 138, with a DPHY interface 140, and with an internal CRM 142. A software code 144 may be stored in the internal CRM 142. The software code 144 may contain one or more components of the ATE test workload code 130, which are downloaded from the ATE machine 110 over the external interface 106 by processor(s) 112 of ATE machine 110 and/or processor(s) 134 of the device under test 102, 104. The software code 144 may include configuration code and/or memory training code downloaded from the ATE machine 110.

Illustratively, component 102 may be an integrated circuit of a computing device 104. Component 102 may include both interconnects 146 and a printed circuit board (“PCB”) 148. Examples of a component 102 may include, without limitation: an integrated circuit, a packaged integrated circuit (e.g., a “chip” or “semiconductor chip”), the processing circuit 132, the computer-readable storage media (“CRM”) 142 (e.g., “memory”), and so on. The processing circuit 132 may be a central processing unit (“CPU”), a graphics processing unit (“GPU”), and so on. By way of example, types of packaged integrated circuits may include: a dual in-line (“DIP”) package, a surface-mount-design package (“SMDP”), a small outline integrated circuit (“SOIC”) package, a quad flat package (“QFP”), a ball grid array (“BGA”), a chip-scale package (“CSP”), a flip-chip package (“FCP”), a pin-grid array (“PGA”) package, a land grid array (“LGA”) package, a plastic leaded chip carrier (“PLCC”) package, a thin small outline package (“TSOP”), and a wafer level chip scale package (“WLCSP”).

DDR Physical Interface (“DPHY”) 140 may include circuitry and/or software that enables DPHY 140 to manage a data transfer protocol between a physical interface 150, such a metal socket (not shown) on PCB 148 and external pin(s) (not shown) of CRM 108. DPHY 140 links CRM 108 with address bus 136, the processing circuit 132, processor(s) 134, internal CRM 142, and external interface controller 138, which is coupled with the external interface 106. In this configuration, the external interface 106 can access a temporary buffer region 152 of CRM 108.

CRM 108 further includes other target region(s) 154 (e.g., target memory address location(s)). A memory size of each of the target region(s) 154 is greater than a memory size of the temporary buffer region 152. The higher memory address locations of the target region(s) 154 enable data segments of the ATE test workload code 130 that are moved out of the temporary buffer region 152 to be staged in the CRM 108 until a complete ATE test workload code 130 (or a component thereof) is stored in the CRM 108. Moving the data segment to a target region 154 clears the target buffer region 152, freeing it up to receive another data segment over the external interface 106. This occurs because a memory size of each data segment of ATE test workload code 130 is less than or equal to a memory size of the temporary buffer region 152.

Each of the processor(s) 112 and/or the processor(s) 134 may include a single-core processor or a multiple-core processor composed of a variety of materials, such as silicon, polysilicon, high-K dielectric, copper, and the like. ATE CRM 114, internal CRM 142, and/or of the device under test 102, 104 may be a hardware base storage media, which does not include transitory signals or carrier waves. As an example, ATE CRM 114 and/or CRM 142 may each include one or more of a read-only memory (“ROM”), a flash memory, a dynamic random-access memory (“DRAM”), a NOR memory, a static random-access memory (“SRAM”), and so on. CRM 108 may be: a RAM, a DRAM, or a synchronous dynamic random access memory (“SDRAM”). Any suitable version of double data write (“DDR”) SDRAM compatible with processor(s) 112, processor(s) 134, processing circuit 132, and PCB 148 can be used in the device under test 102, 104 to store the transferred and staged ATE test workload code 130 (or a complete component thereof). Examples of suitable DDR versions may include: DDR1, DDR2, DDR3, DDR4, DDR5, and so on.

At least one of external interface controller 138 of the device under test 102, 104 and ATE external interface controller 128 may enable operative elements of the processing circuit 132 of the device under test 102, 104, including processor(s) 134, to read, write, copy, receive, transmit, and so on, data segment(s) of the ATE test workload code 130 and/or software code 144 over the external interface 106. Due to limits imposed by an address bus width of the external interface 106, a memory size of each data segment will be less than or equal to an available memory size of the temporary buffer region 152.

Depending on its software architecture, the ATE test workload code 130 stored in ATE CRM 114 may include one or more components, each of which include executable code or computer-readable instructions that when executed by the processor(s) 112 of the ATE machine 110 (and/or the processor(s) 134 of device under test 102, 104) to direct operative elements of the ATE machine 110 to download (or transfer) data segment(s) of the ATE test workload code 130 to the DRAM computer-readable storage media (“CRM”) 108 of the device under test 102, 104. For example, ATE test workload code 130 may include a component of software code 144 that includes configuration code and/or memory training code. The configuration code may include data and/or information that reset and/or trigger operation of the one or more processor(s) 134. The memory training code may include data and/or information that initialize, configure, train, and operate the CRM 108, external interface controller 138, and DPHY 140. The ATE test workload code may also include actual test workload code that enables performing a functional test of the device under test 102, 104.

In FIG. 1, software code 144 is illustratively shown stored in internal CRM 142 (“internal memory 1”) of the device under test 102, 104. Component(s) of the software code 144 may configure the processor(s) 134 and/or the component external interface controller 138 with configuration instructions. Component(s) of the software code 144 may further configure the processor(s) 134, the DPHY interface 140, and/or the CRM 108 with memory training instructions, including: training instructions for DDR-DRAM and DDR-SDRAM types of computer-readable storage media. Thus, the software code 144 may include executable code (e.g., computer-readable instructions) that when executed by one or more processor(s) 134, of the processing circuit 132, of the device under test 102, 104, may cause the one or more processor(s) 134 to configure, initialize, train, and/or operate the component external interface controller 138, the DPHY interface 140, and the CRM 108.

The external interface controller 138 may be implemented in software, firmware, and/or hardware. The component external interface controller 138 is configured with circuitry and/or software that implement data transfer protocols that allow the component external interface controller 138 and/or processor(s) 134 to communicate with an element of ATE machine 110, such as: ATE external interface controller 128, processor(s) 112 of ATE machine 110, and/or ATE computer-readable storage media 114.

### Example Operational Overview

Referring again to FIG. 1, if an address bus width of the external interface 106 is limited, for example, to 32 bits, the external interface 106 will only be able to access a fraction (e.g., temporary buffer region 152) of a total available memory space of the CRM 108. To overcome this memory constraint and enable loading and executing the complete ATE test workload code 130, a processor-based, phased-data staging technique is used. In FIG. 1, this approach is depicted in FIG. 1 by arrow 156 and by arrow 158.

Arrow 191, which curves clockwise in FIG. 1, represents an operating principle by which external interface 106 is used to transfer and download data segment(s) of ATE test workload code 130 from the ATE machine 110 into the directly addressable region (e.g., temporary buffer region 152) of the CRM 108. Subsequently, arrow 192, which curves counterclockwise, represents another operating principle by which the processing circuit 132, which includes one or more processor(s) 134, can be operated iteratively to move the downloaded data segments to other target region(s) 154 of the CRM 108. Since each of these target region(s) 154 has a higher memory address location than the temporary buffer region 152, they are beyond what the external interface 106 can directly access given its limited (32 bit) address bus width. Consequently, this iterative technique enables the processor(s) 134 of a device under test 102, 104 to use as much of the CRM 108 as needed, up to all of its available memory, to stage, store, and execute a complete ATE test workload code 130 (or a complete component thereof), even when the ATE test workload code 130 (or a component thereof) has a size larger than a size of the temporary buffer region 152. Thereafter, the processor(s) 134 and/or the processor(s) 112 of the ATE machine 110 can be used to access, read, and execute, from the target region(s) 154 of the CRM 108, the complete ATE test workload code 130 (or components thereof) that were downloaded over the external interface 106. Illustratively, this technique allows performing a larger and/or more complex functional test of the device under test 102, 104. A signal indicative of Test Pass or Test Fail can be output once a functional test has completed. This signal may be output to the ATE machine 110. This technique also enables performing a complex functional test of one or more other element(s) of the device under test 102, 104, such as core(s) (not shown) of processor(s) 134).

### Computer Implemented Method(s)

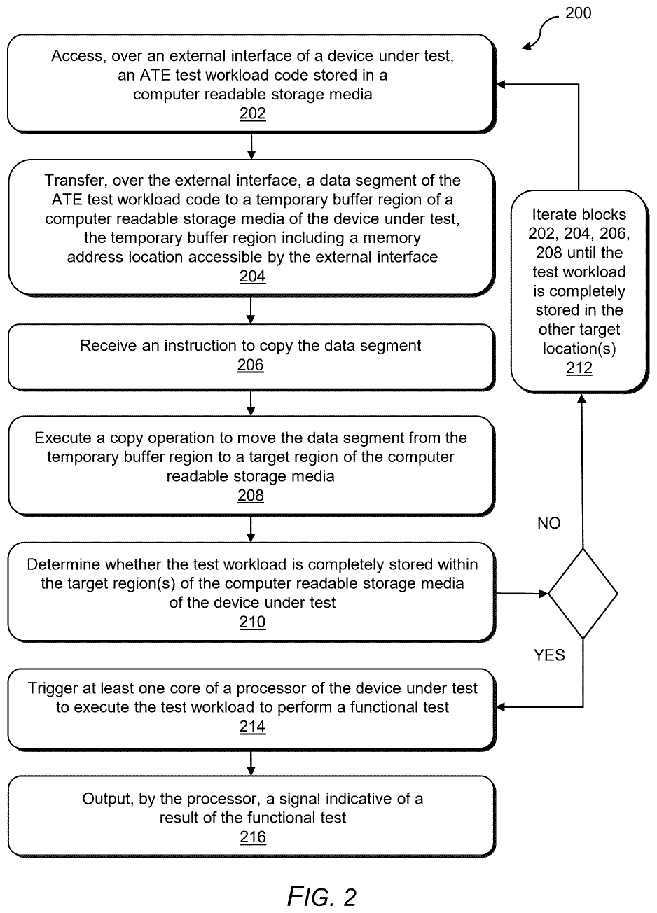

FIG. 2 depicts an example computer implemented method 200 to overcome external interface memory address limitations using processor-assisted data staging on a device under test (“DUT”) 102, 104 (shown in FIG. 1). Method 200 is shown as a set of blocks that specify operations performed by one or more processor(s) 134 (FIG. 1), but such operations are not necessarily limited to the order or combinations shown in FIG. 2. Unless specified otherwise, one or more of the operations shown may be repeated, combined, reorganized, or linked to provide a wide array of additional and/or alternate methods. In portions of the following discussion, reference may be made to the example testing environment 100 of FIG. 1 or to entities or processes as detailed in other drawings, reference to which is made for example only. The techniques are not limited to performance by one entity or multiple entities operating on one device.

Illustratively, method 200 may be performed by element(s) of device under test 102, 104 (FIG. 1), including a processing circuit 132 of a device under test 102, 104. When functional component(s) of the ATE test workload code 130 (FIG. 1) are executed by the processor(s) 134 (FIG. 1), the device under test 102, 104 (and/or the ATE machine 110) operates to perform one or more steps of the method 200.

Referring now to FIG. 2 (with reference to FIG. 1 as needed), starting at block 202, the ATE test workload code 130 (FIG. 1) stored in ATE CRM 114 (FIG. 1) of the ATE machine 110 is accessed over the external interface 106. This accessing step may be performed by the processor(s) 134 and/or the processor(s) 112 of ATE machine 110. This accessing step may include downloading the software code 144 into the internal CRM 142 of the device under test 102, 104.

At block 204, a data segment of the ATE test workload code 130 (or of a component thereof) is transferred over the external interface 106. If the data segment contains configuration data and/or memory training data, this transferring step may further include storing the data segment in the internal CRM 142 of the device under test 102, 104. If the data segment contains an ATE test workload, this transferring step may include storing the data segment in the temporary buffer region 152 of the CRM 108 of the device under test 102, 104.

At block 206, processor(s) 134 (FIG. 1) may receive an instruction to copy the accessed (and downloaded) data segment that is stored in the temporary buffer region 152. This instruction may originate from the software code 144 after it is downloaded over the external interface 106 into internal CRM 142 and/or may originate from the ATE machine 110.

At block 208, the processor(s) 134 (FIG. 1) may execute a copy operation to move the (accessed) data segment from temporary buffer region 152 to a target region 154 of CRM 108 of the device under test 102, 104.

At block 210, the processor(s) 134 (FIG. 1) may operate to determine whether the ATE test workload code 130 (or a component thereof) is completely stored either in the internal CRM 142 or in the target region(s) 154 of the CRM 108 of the device under test 102, 104. If no, method 200 may proceed to block 212. If yes, method 200 may proceed to block 214.

At block 212, when it has been determined that the ATE test workload 130 (or a component thereof) has not been completely transferred and stored in the internal CRM 142 and/or in the CRM 108, the processor(s) 134 (FIG. 1) may operate to iteratively perform the operations of blocks 202, 204, 206, and 208 of method 200 until a determination occurs that transfer of the complete ATE test workload code 130 (or of a component thereof) is finished.

At block 214, after it has been determined that the complete ATE test workload 130 (or a component thereof) has been transferred over the external interface 106 and stored in either the internal CRM 142 and/or in the CRM 108, then the processor(s) 134 (or alternatively, the processor(s) 112 of ATE machine 110) (FIG. 1) may operate to trigger at least one core of the processor(s) 134 to access, read, and execute at least one component of the completely transferred and stored ATE test workload code 130 to perform a functional test of the device under test 102, 104 (or of an element thereof, such as a core of one or more of the processor(s) 134).

At block 216, the processor(s) 134 and/or the processor(s) 112 of ATE machine 110 (FIG. 1) may output a signal indicative of a result (e.g., TEST PASS or TEST FAIL) of the functional test. Thereafter, method 200 may end.

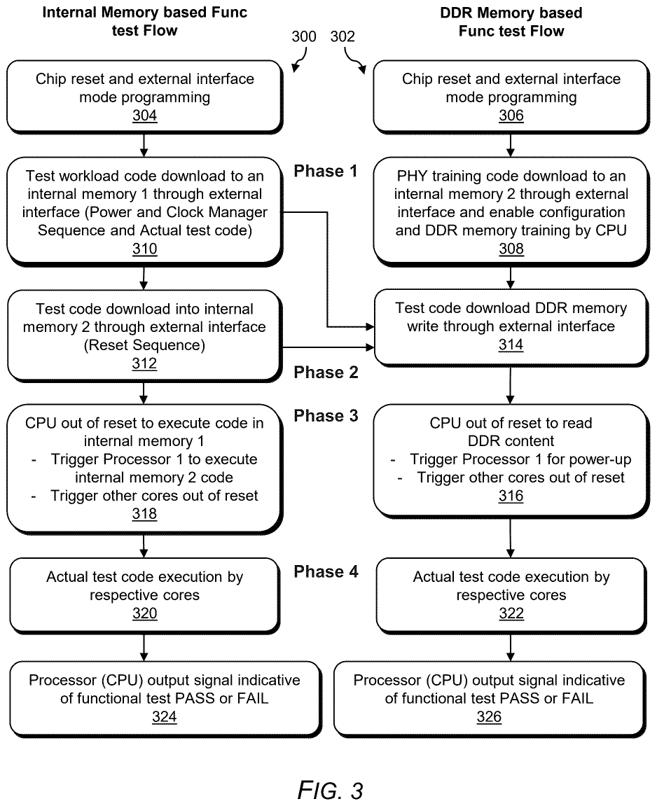

FIG. 3, with reference to FIG. 1 as needed, illustrates examples of correlative functional test methods 300, 302 for an internal CRM 142 (FIG. 1) and/or for a CRM 108 of a device under test 102, 104. Computer implemented method 300 is shown as a set of blocks 304, 310, 312, 318, 320, and 324 that specify operations that may be performed by one or more processor(s) 134 (FIG. 1) of the device under test 102, 104. Similarly, computer implemented method 302 is shown as a set of blocks 306, 308, 314, 316, 322, and 326. However, such operations are not necessarily limited to the order or combinations shown in the exemplary methods 300, 302 of FIG. 3. Unless specified otherwise, one or more of the operations shown may be repeated, combined, reorganized, or linked to provide a wide array of additional and/or alternate methods. In portions of the following discussion, reference may be made to the testing environment 100 of FIG. 1 or to entities or processes as detailed in other drawings, reference to which is made for example only. The techniques are not limited to performance by one entity or multiple entities operating on one device.

This discussion of exemplary methods 300 and 302 assumes that the ATE machine 110 (FIG. 1) is coupled over an external interface 106 (having a 32 bit address bus width) with a device under test 102, 104. It further assumes that software code 144 (which may include configuration and/or memory training instructions) was either downloaded from the ATE machine 110 over the external interface 106 or was otherwise pre-installed in internal CRM 142 of the device under test 102, 104.

With this in view, the multi-phase methods(s) 300, 302, which FIG. 3 illustratively depict, may start at block 304 and block 306, respectively. For example, at block 304 of method 300, the CRM 108 undergoes a chip reset; and may load programming (e.g., computer-readable instructions from software code 144) that initializes, configures, and/or operates external interface 106. Similarly, at block 306 of method 302, the CRM 142 of the device under test 102, 104 also undergoes a chip reset; and may also load programming that trains and/or enables the temporary buffer region 152 of the CRM 108 to be accessible to the external interface 106.

At block 308 of method 302, PHY training code (which may be included in, or separate from, software code 144) may be downloaded into the internal CRM 142 (FIG. 1) over the external interface 106; and configuration & DDR DRAM memory training may be enabled by processor(s) 134 of the device under test 102, 104. At block 308 of FIG. 3, the phrase “internal memory 2” denotes the internal CRM 142.

Referring now to block 310 of workflow 300, a data segment of ATE test workload code 130 (FIG. 1) is downloaded to a temporary buffer region 152 (FIG. 1) of the CRM 108 (which may be a DDR SDRAM internal to the device under test 104). At block 310 of FIG. 3, the phrase “internal memory 1” denotes the CRM 108, into which the ATE test workload code 130 (FIG. 1) is staged through the external interface 106. Illustratively, component(s) of the ATE test workload code 130 transferred by the downloading operation represented by block 310 may include either or both of: a Power and Clock Manager (“PCM”) sequence and actual functional test code that is configured to validate and/or test a hardware design of the component 102 of the device under test 104.

Referring again to method 300, at block 312, additional ATE test workload code 130 (FIG. 1) may be downloaded through the external interface 106 into internal CRM 142 (e.g., “memory 2”) of the device under test 102, 104. This additional code may include, by way of example, a reset sequence.

Now referring back to method 302, at block 314, processor(s) 134 iteratively download one or more data segment(s) of the ATE test workload code 130 (FIG. 2) through external interface 106 and perform a DDR write operation to store them within target region(s) 154 of CRM 108.

At block 316 of method 302, processor(s) 134 may come out of a reset state to read data (“DDR content”) stored in CRM 108. This data, when executed by the processor(s) 134 may trigger a core (“Processor 1”) for a power-up; and trigger other core(s) out of reset.

At block 318 of method 300, processor(s) 134 may come out of the reset state to access, read, and execute the ATE test workload code 130 now staged in the other target region(s) of the CRM 108. Illustratively, operation of coming out of a reset state may trigger a core (“Processor 1”) to execute the complete ATE test workload code 130 (e.g., “Internal Memory 2 code”) transferred over the external interface 106 and stored in the target region(s) 154 of the CRM 108. This operation of coming out of a reset state may also trigger other core(s) out of reset.

At block 320 of method 300 and at correlative block 322 of method 302, the processor(s) 134 may operate to actually execute the ATE test workload code 130 (FIG. 1), thereby causing one or more functional test(s) of the device under test 102, 104 to be performed.

At block 324 of method 300 and at correlative block 326 of method 302, at least one of the processor(s) 134 may operate to output a signal indicative of a result of a functional test, e.g., a TEST PASS signal or a TEST FAIL signal. Thereafter, both method 300 and method 302 may end.

### Example Processing Circuit Software/Firmware Architecture

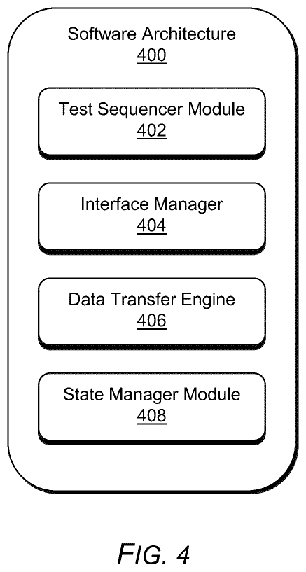

FIG. 4 is a block diagram illustrating an example software architecture 400 that may be used to configure at least the processing circuit 132 of FIG. 1 to perform the operations represented in the steps of methods 200, 300 and 302. This architecture may be implemented as a set of functional components (“modules”) of software that are executed by one or more processor(s) and/or microcontrollers that form the processing circuit 132. For example, a “Test Sequencer” software component 402 may be configured to orchestrate the overall data staging process. Computer-readable code of this component may include logic to determine a size of each data segment, a location of the temporary buffer, and final (target) destination addresses for each data segment. Similarly, an Interface Manager component 404 may contain computer-readable code that facilitates communication with the external interface 106 (FIG. 1). This Interface Manager component 404 may provide (or handle) one or more data transfer protocols required to receive a data segment from the ATE machine 110 and transfer it over the external interface 106 and into the designated temporary buffer region 152 in the CRM 108. Also, a Data Transfer Engine component 406 may include computer-readable code that enables operative elements of the processing circuit 132 to perform a high-speed, memory-to-memory copy operation. For example, upon instruction from the Test Sequencer component 402, this Data Transfer Engine component 406 would cause processor(s) 134 to read a data segment from an ATE source buffer address in ATE CRM 114 and write it to the destination address location of the temporary buffer region 152 of the component CRM 108.

Finally, a State Manager component 408 may be used to transition the processing circuit 132 between different operational states. For example, this component may configure the processor(s) 134 in and out of reset and/or may configure the processor(s) 134 to execute a ‘data-receive’ state, and a ‘data-copy’ state. Logic in the computer-readable code of the State Manager component 408 ensures that external load operations and internal copy operations do not conflict. Thus, data flow from the ATE machine 110 to the component 102 may be initiated by the Test Sequencer component 402, which directs the Interface Manager component 404 to receive a data segment, which has a memory size equal to or less than a memory size of the temporary buffer region 152 of the CRM 108. Once the data segment has been received over the external interface 106, the State Manager component 408 may signal a state change. Then, the Test Sequencer component 402 may instruct the Data Transfer Engine component 406 to perform a copy operation that moves the data segment out of the temporary buffer region 152 to a target region 154 of the CRM 108. This cycle may iteratively repeat until logic coded in the Test Sequencer component 402 that is executed by processor(s) 134 determines the entire ATE test workload code is staged in the CRM 108.

Embodiments of the computer-implemented methods 200, 300 and 302 can be performed by various processing systems. Structural equivalents include, but are not limited to, a general-purpose computer programmed with specific software, a dedicated hardware accelerator, or a cloud-based computing environment configured to execute the conversion operations and manipulation operations set forth in this document.

The preceding discussion describes systems and techniques related to generating a dynamic test pattern file directly from compiled code that corresponds to a hardware design of a component of a computing device and directly modifying the dynamic test pattern file so that a full functional simulation of the hardware design is bypassed. These techniques may be implemented using one or more of the components shown in the drawings. Thus, these drawings illustrate some of the many possible systems or apparatuses capable of employing the described techniques.

What is claimed is:

1. A computer implemented method, comprising:
accessing, by a processor of a device under test and over an external interface that is coupled with the processor, an automatic test equipment test workload code;
transferring, by the processor and over the external interface, a data segment of the automatic test equipment test workload code to a temporary buffer region of a computer-readable storage media;
receiving, by the processor, an instruction to move the data segment; and
executing, by the processor, a copy operation to move the data segment from the temporary buffer region to a target region of the computer-readable storage media.

2. The computer implemented method of claim 1, wherein the temporary buffer region includes a memory address location of the computer-readable storage media that is accessible by the external interface.

3. The computer implemented method of claim 1, further comprising:
determining, by the processor, that the automatic test equipment test workload code has been completely transferred and stored in the target region; and
triggering, by the processor, execution of at least a component of the completely transferred and stored test workload code to perform a functional test of the device under test.

4. The computer implemented method of claim 3, wherein the step of triggering, by the processor, execution of at least a component of the test workload code further comprises:
triggering, by the processor, at least one core of the processor to perform the functional test; and
outputting, by the processor, a signal indicative of a result of the functional test.

5. The computer implemented method of claim 1, wherein the computer-readable storage media is a double data write synchronous dynamic random access memory.

6. The computer implemented method of claim 1, wherein the external interface has an address bus width of 32 bits.

7. The computer implemented method of claim 1, wherein the automatic test equipment test workload code has a size greater than a size of the temporary buffer region.
